(19) United States
(12) Patent Application Publication
(10) Pub. No.: US 2018/0034795 A1
(43) Pub. Date: Feb. 1, 2018

(54) Simplified Configuration of Computing Devices for Use with Multiple Network Services

(71) Applicant: Microsoft Technology Licensing, LLC, Redmond, WA (US)

(72) Inventors: David Los, Everett, WA (US); Hayley Lynn Steplyk, Redmond, WA (US)

(21) Appl. No.: 15/224,235

(22) Filed: Jul. 29, 2016

(51) Int. Cl. H04L 29/06; H04L 29/08

(52) U.S. Cl. CPC H04L 63/08; H04L 67/16; H04L 63/102

(57) ABSTRACT

An account aggregation service receives account credentials for a first network service account and associates the credentials with a list of network service accounts. Access tokens for other network service accounts can also be obtained and stored with the list of accounts. The account aggregation service can utilize the access tokens to access the other network services on behalf of a user. The account aggregation service can also enable the configuration of a second or subsequent computing device by receiving the credentials for the first network service account. The account aggregation service can then utilize the account credentials to retrieve the associated list of accounts. The list of accounts can then be provided to the second or subsequent computing device. The second or subsequent computing device can access the other network service accounts via the account aggregation service.

### BACKGROUND

In today's highly connected society, it is quite common for individuals to utilize many different types of network services. For example, and without limitation, individuals might have multiple email accounts, multiple network service accounts for storing files, social networking accounts, calendaring accounts, and other types of network service accounts for performing other types of network-based functionality.

It is also quite common for individuals to have multiple computing devices that access all of their network service accounts. For example, individuals might have a smartphone, a tablet or slate computing device, and a laptop or desktop computer. A user can configure each of their computing devices to access all of their network service accounts.

Configuration of multiple network service accounts on multiple computing devices can, however, be time consuming and frustrating for users. For example, users might not remember their credentials (e.g. their username and password) for all of their network service accounts. Users might also have difficulty typing their network service account credentials on small touchscreen-based computing devices. As a result, it is not uncommon for users to not configure all of their network service accounts on all of their devices.

It is also not uncommon for users to utilize short and simple passwords for their network service accounts in order to enable easier and more accurate typing of the passwords on small touchscreen-based computing devices. Short and simple passwords can, however, seriously jeopardize the security of data stored using the network service accounts.

It is with respect to these and other considerations that the disclosure made herein is presented.

### SUMMARY

Technologies are described herein for simplified configuration of computing devices for use with multiple network services. Through an implementation of the technologies disclosed herein, a user can configure multiple network service accounts on a single computing device. The user can then configure the same network service accounts on their other computing devices utilizing credentials from only one of the network service accounts. By enabling simple configuration of a user's computing devices in this manner, users can easily utilize longer passwords than previously possible. Through the use of such passwords, the security of a user's network service accounts can be greatly improved. Technical benefits other than those specifically identified herein can also be realized through an implementation of the disclosed technologies.

According to one configuration disclosed herein, a user can configure a first computing device, such as a tablet or smartphone, to access a first network service (which might be referred to herein as a “primary” network service). For example, and without limitation, the user might provide credentials (e.g. a username and password) for accessing the first network service (which might be referred to herein as “primary account credentials”). An account aggregation service can receive the primary account credentials and store the primary account credentials in a secure data store. The primary account credentials can also be associated with a list of accounts that identifies the network service accounts that the user has configured.

The user can then configure the first computing device to access a second network service (which might be referred to herein as a “secondary” network service). When configuring the second network service account, a user interface (“UI”) can be presented that asks the user if they would like to associate their primary network service account with the secondary network service account. If the user indicates that they would like to associated the secondary network service account with the primary network service account, the account aggregation service can redirect the first computing device to the secondary network service. The user can then provide their account credentials (e.g. a username and password) for the secondary network service account to the secondary network service. In turn, the secondary network service can provide an authorization code to the first computing device.

The first computing device can then provide the authorization code to the account aggregation service. The account aggregation service can then utilize the authorization code to obtain an access token, such as an OAuth access token, from the secondary network service. The access token allows the account aggregation service to access the secondary network service on behalf of the user. The access token can then be stored in the list of accounts associated with the user, along with other data for the secondary network service, such as its Uniform Resource Locator (“URL”) or another type of network address and/or data identifying a type of the network service (e.g. email service, calendaring service, or social networking service). The first computing device can be configured to access virtually any number of secondary network services in a similar fashion.

The account aggregation service can also provide functionality for enabling a user's computing devices to access the primary and secondary network services. The account aggregation service can receive requests from the computing devices to access the network services. In response to receiving such requests, the account aggregation service can utilize the appropriate access token to access the network services on behalf of the user. Data obtained from the network services can then be returned to the computing device in response to the original request. The account aggregation service can enable access to virtually any number of network services in a similar fashion. For instance, the account aggregation service could enable unified access to multiple email services. The user's computing device can also access the primary and secondary network services directly.

The account aggregation service can also enable the configuration of a user's other computing devices in a simplified fashion. In particular, in order to configure a user's network service accounts on a second computing device, such as another smartphone or tablet computing device, the user simply has to identify their primary network service and provide their credentials for accessing the primary network service. The account aggregation service can then utilize the primary account credentials (e.g. the username for the primary network service) to retrieve the list of accounts associated with the user. The list of accounts can then be provided to the second computing device.

The user can specify the network service accounts in the list of accounts that are to be configured on the second computing device. Once the user has specified the accounts, the specified network service accounts can be accessed by the account aggregation service using the previously acquired access tokens in the manner described above. The list of accounts can also be made available to an operating system and application programs executing on the second computing device for use in a similar fashion. In this way, the user only has to provide their credentials for their secondary network service accounts one time in order for these accounts to be provisioned on all of their computing devices.

It is to be appreciated that the above-described subject matter can be implemented as a computer-controlled apparatus, a computer process, a computing system, or as an article of manufacture such as a computer readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is a network diagram showing aspects of one mechanism disclosed herein for configuring a primary network service account on a first computing device, according to one configuration disclosed herein;

FIG. 1B includes several flow diagrams that illustrate aspects of several routines that further describe the mechanism shown in FIG. 1A for configuring a primary network service account on a first computing device, according to one configuration disclosed herein;

FIG. 2A is a network diagram showing aspects of one mechanism disclosed herein for configuring one or more secondary network service accounts on the first computing device shown in FIG. 1A, according to one configuration disclosed herein;

FIG. 2B includes several flow diagrams showing aspects of several routines that together further illustrate the mechanism shown in FIG. 2A for configuring one or more secondary network service accounts on the first computing device shown in FIG. 1A, according to one configuration disclosed herein;

FIG. 3A is a network diagram showing aspects of one mechanism disclosed herein for retrieving data from one or more secondary network services via an account aggregation service, according to one configuration disclosed herein;

FIG. 3B is a flow diagram showing aspects of a routine that further illustrates the mechanism shown in FIG. 3A for retrieving data from one or more secondary network services via an account aggregation service, according to one configuration disclosed herein;

FIG. 4A is a network diagram showing aspects of one mechanism disclosed herein for configuring one or more secondary network service accounts on a second computing device, according to one configuration disclosed herein;

FIG. 4B includes several flow diagrams showing aspects of several routines that further illustrate the mechanism shown in FIG. 4A for configuring one or more secondary network service accounts on a second computing device, according to one configuration disclosed herein;

FIG. 5 is a computer architecture diagram showing an illustrative computer hardware and software architecture for a computing system that is capable of implementing aspects of the technologies presented herein;

FIG. 6 is a computer system architecture and network diagram illustrating a distributed computing environment capable of implementing aspects of the technologies presented herein; and

FIG. 7 is a computer architecture diagram illustrating a computing device architecture for another computing device that is capable of implementing aspects of the technologies presented herein.

### DETAILED DESCRIPTION

The following detailed description is directed to technologies for simplified configuration of computing devices for use with multiple network services. As discussed briefly above, through an implementation of the technologies disclosed herein, users can easily utilize longer passwords than previously possible. Through the use of such passwords, the security of a user's network service accounts can be greatly improved. Technical benefits other than those specifically identified herein can also be realized through an implementation of the disclosed technologies.

While the subject matter described herein is presented in the general context of program modules that execute in conjunction with the execution of an operating system and application programs on a computer system, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration as specific configurations or examples. Referring now to the drawings, in which like numerals represent like elements throughout the several FIGS., aspects of various technologies for simplified configuration of computing devices for use with multiple network services will be described.

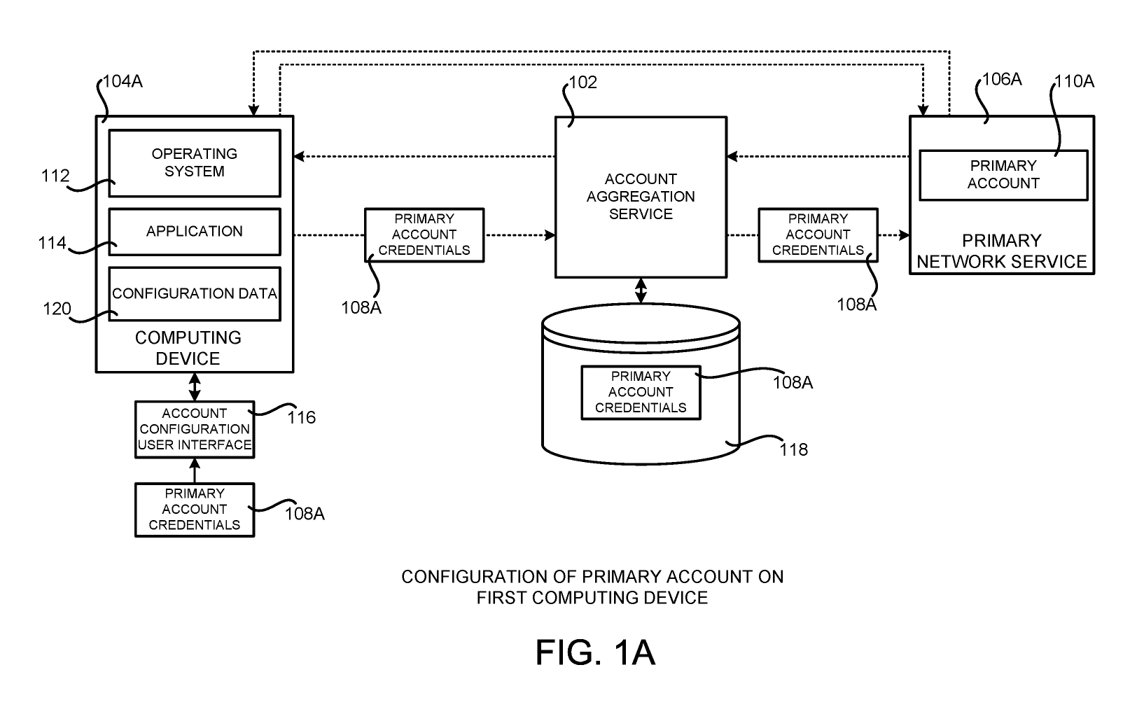

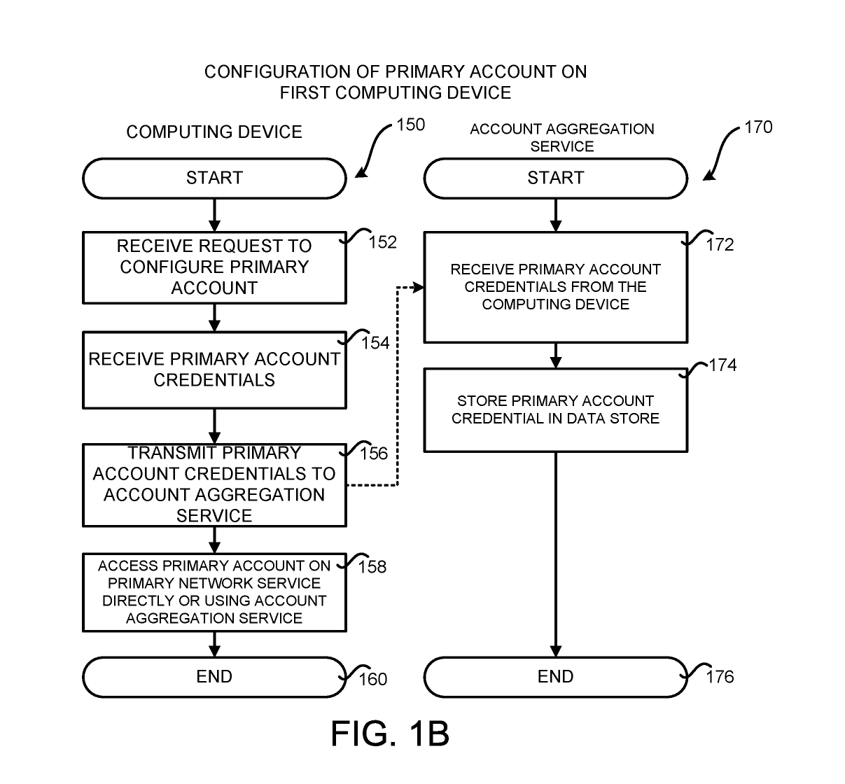

FIG. 1A is a network diagram showing aspects of one mechanism disclosed herein for configuring a first computing device 104A to access a primary account 110A on a primary network service 106A, according to one configuration disclosed herein. As illustrated in FIG. 1A, a user can configure a first computing device 104A, such as a tablet or smartphone, to access a first network service 110A (which might be referred to herein as the “primary” network service 110A).

In order to enable this functionality, an operating system 112 or an application 114 executing on the first computing device 104A can provide an account configuration UI 116. The user can supply their credentials 108A (e.g. a username and password) for accessing the primary network service 110A (which might be referred to herein as “primary account credentials 108A”) through the account configuration UI 116. The primary account credentials 108A can be cached on the first computing device 104A (e.g. in the configuration data 120) for use by the operating system 112 or the application 114 in directly accessing the primary network service 106A.

The operating system 112 or application 114 can also transmit the primary account credentials 108A to an account aggregation service 102. The account aggregation service 102 is a network service configured to receive the primary account credentials 108A and store the primary account credentials 108A in a secure data store 118. The account aggregation service 102 can also utilize the primary account credentials 108A to access the primary network service 106A on behalf of the user and to obtain data from the primary network service 106A. The data can then be returned to the operating system 112 or the application 114 executing on the computing device 104A.

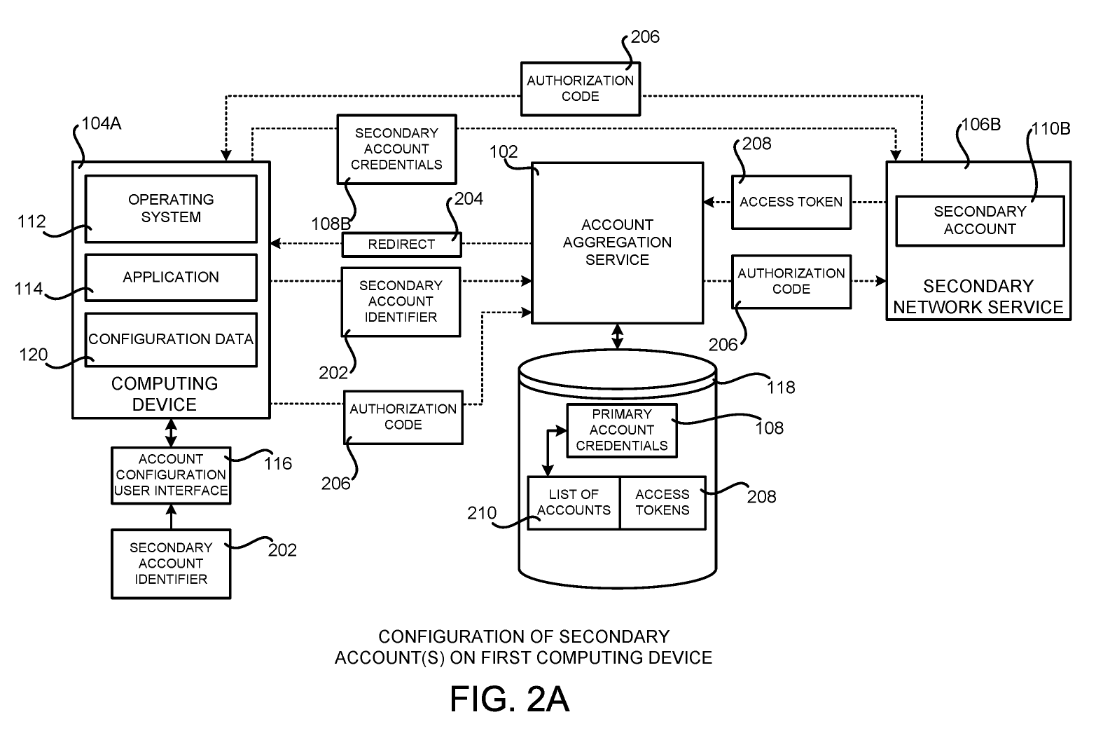

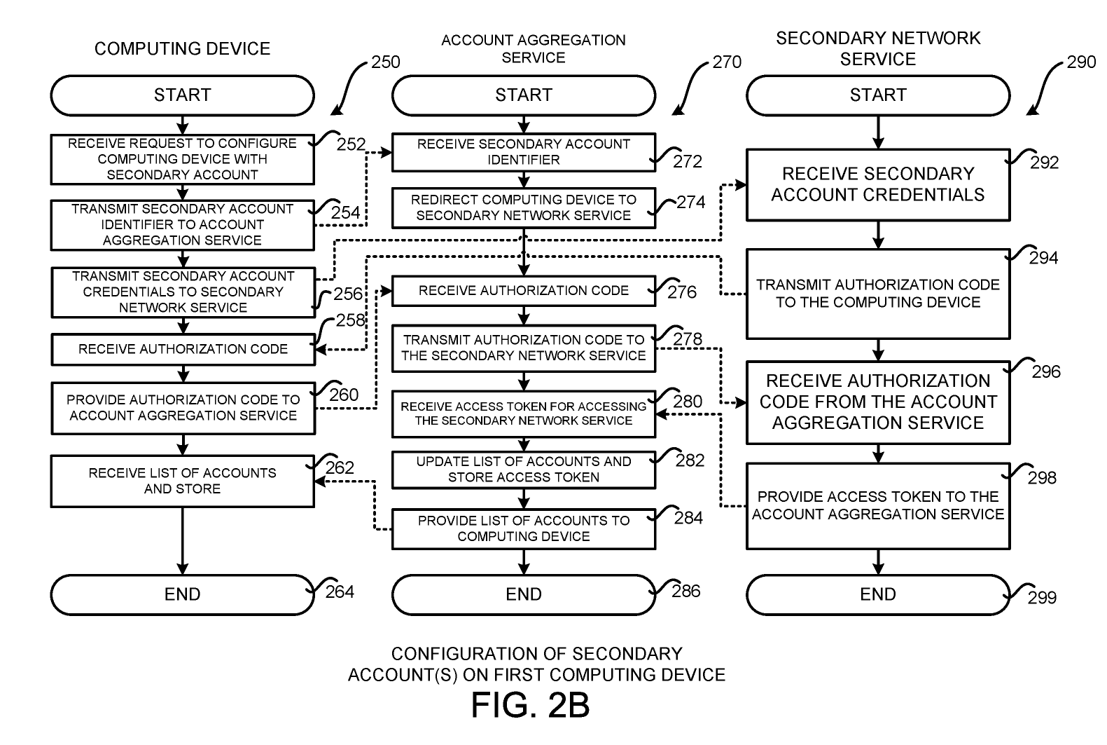

As will be described in greater detail below, the primary account credentials 108A can also be associated with a list of accounts (not shown in FIG. 1A) that identifies the various network service accounts that the user has configured. The account aggregation service 102 can also obtain access tokens (also not shown in FIG. 1A) for other network services and utilize the access tokens to access the network services on behalf of the user. The access tokens can also be stored within or in associated with the list of accounts. The list of accounts can be utilized to easily configure other computing devices to access the network services. Additional details regarding these processes will be provided below with regard to FIGS. 2A-4B.

FIG. 1B includes several flow diagrams showing aspects of two routines 150 and 170, which will be described together, that together further illustrate the mechanism shown in FIG. 1A for configuring a primary account 110A on a first computing device 104A, according to one configuration disclosed herein. It should be appreciated that the logical operations described herein with regard to FIG. 1B and the other FIGS. can be implemented (1) as a sequence of computer implemented acts or program modules running on a computing system and/or (2) as interconnected machine logic circuits or circuit modules within the computing system.

The particular implementation of the technologies disclosed herein is a matter of choice dependent on the performance and other requirements of the computing system. Accordingly, the logical operations described herein are referred to variously as states, operations, structural devices, acts, or modules. These states, operations, structural devices, acts and modules can be implemented in software, in firmware, in special purpose digital logic, and any combination thereof. It should also be appreciated that more or fewer operations can be performed than shown in the FIGS. and described herein. These operations can also be performed in a different order than those described herein.

The routine 150 begins at operation 152, where the computing device 104A receives a request to configure the primary account 110A on the primary network service 106A. The request might be provided, for instance, through the account configuration UI 116. In response to receiving such a request, the routine 150 proceeds to operation 154, where the primary account credentials 108A are received. In one configuration, the primary account credentials 108A include a username and password for the primary account 110A. Other types of credentials can be utilized in other configurations.

From operation 154, the routine 150 proceeds to operation 156, where the computing device 104A transmits the primary account credentials 108A to the account aggregation service 102. The account aggregation service 102 receives the primary account credentials at operation 172 of the routine 170. The routine 170 then proceeds from operation 172 to operation 174, where the account aggregation service 102 stores the primary account credentials 108A in an appropriate data store 118. The primary account credentials 108A can be encrypted or otherwise secured prior to storage. As discussed above, the account aggregation service 102 can utilize the primary account credentials 108A to access the primary account 110A on behalf of the user in some configurations. The routine 170 proceeds from operation 174 to operation 176, where it ends.

The routine 150 proceeds from operation 156 to operation 158, where the computing device 104A can also utilize the primary account credentials 108A to access the primary network service 106A. From operation 158, the routine 150 proceeds to operation 160, where it ends.

FIG. 2A is a network diagram showing aspects of one mechanism disclosed herein for configuring one or more secondary network service accounts 110B on the first computing device 104A shown in FIG. 1A, according to one configuration disclosed herein. As shown in FIG. 2A, a user of the computing device 104A can request to configure the computing device 104A to access a secondary account 110B on a secondary network service 106B. For example, the user might provide a secondary account identifier 202 to the computing device 104A via the account configuration UI 116. The secondary account identifier 202 can be a network address, URL, name, or other unique identifier of the secondary network service 106B.

When the user requests to configure the computing device 104A to access the secondary account 110B, the account configuration UI 116 can ask the user if they would like to associate their primary network service account 110A with the secondary network service account 110B. If the user indicates that they would like to associated the secondary network service account 110B with the primary network service account 110A, the account aggregation service provide a redirect message 204 to the first computing device 104A, thereby redirecting the computing device 104A to the secondary network service 106B (or another network service configured to issue access tokens 208 for the secondary network service). The user can then provide their account credentials 108B (e.g. a username and password) for the secondary network service account 110B to the secondary network service 106B. In turn, the secondary network service 106B can provide an authorization code 206 to the first computing device 104A.

The first computing device 104A can then provide the authorization code 206 to the account aggregation service 102. The account aggregation service 102, in turn, can then utilize the authorization code 206 to obtain an access token 208 from the secondary network service 106B. The access token 208 allows the account aggregation service 102 to access the secondary network service 110B on behalf of the user. In one particular implementation, the access token 208 is an OAuth 2.0 bearer token that is obtained or generated by the secondary network service 106B or another service generated to issue access tokens for the secondary network service 106B. Other types of access tokens 208 and issuance mechanisms can, however, be utilized in other configurations.

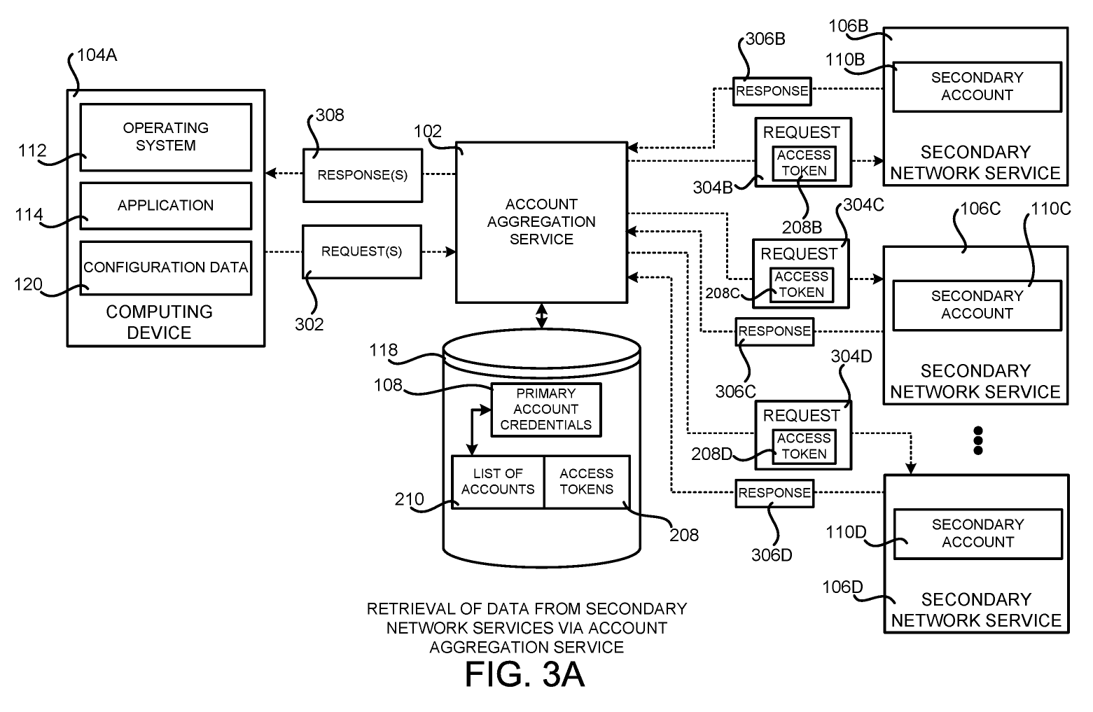

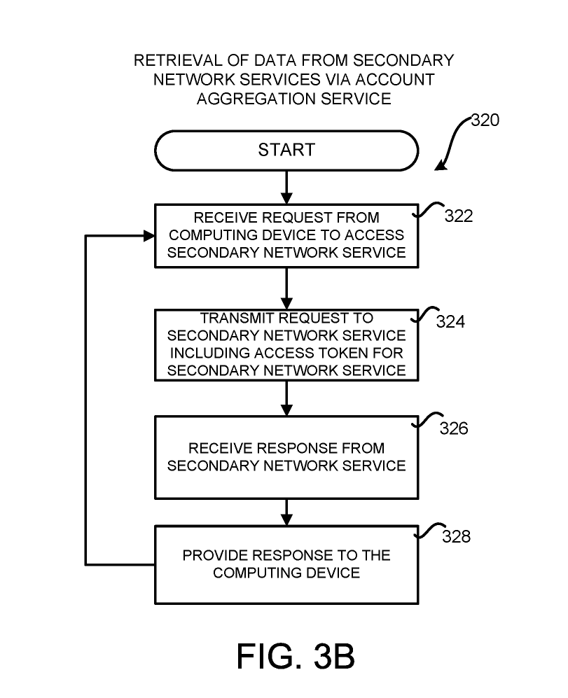

As also shown in FIG. 2A, the access token 208 for the secondary account 110B can then be stored in a list of accounts 210 associated with the primary account credentials 108, along with other data for the secondary network service 106B, such as its Uniform Resource Locator (“URL”) or another type of network address and/or data identifying a type of the network service (e.g. email service, calendaring service, or social networking service). The first computing device 104A can be configured to access virtually any number of secondary network services 106B in a similar fashion. The manner in which the computing device 104A can access the secondary network services 106 through the account aggregation service 102 is described below with regard to FIGS. 3A and 3B.

FIG. 2B includes several flow diagrams that show aspects of several routines 250, 270, and 290 that together further illustrate the mechanism shown in FIG. 2A for configuring one or more secondary network service accounts 110B on the first computing device 104A shown in FIG. 1A, according to one configuration disclosed herein. The routine 250 illustrates aspects of the operation of the computing device 104A, the routine 270 illustrates aspects of the operation of the account aggregation service 270, and the routine 290 illustrates aspects of the operation of the second network service 106B (or another network service configured to issue access tokens 208 on behalf of the second network service 106B). The routines 250, 270, and 290 will be described in detail below.

The routine 250 begins at operation 252, where a request is received to configure the computing device 104A to access the secondary account 110B. The routine 250 then proceeds from operation 252 to operation 254, where the operating system 112 or the application 114 executing on the computing device 104A transmits the secondary account identifier 202 to the account aggregation service 102.

The account aggregation service 102 receives the secondary account identifier 202 at operation 272 of the routine 270. The routine 270 then proceeds from operation 272 to operation 274, where the account aggregation service 102 provides a redirect message 204 to the computing device 104A, thereby causing the computing device 104A to be redirected to the secondary network service 106B (or another service configured to issue access tokens 208 on behalf of the secondary network service 106B).

From operation 254, the routine 250 proceeds to operation 256, where the operating system 112 or the application 114 receives the secondary account credentials 108B from the user and transmits the secondary account credentials 108B to the secondary network service 106B. The secondary network service 106B receives the secondary account credentials 108B at operation 292 of the routine 290.

The routine 290 then proceeds from operation 292 to operation 294, where the secondary network service 106B generates an authorization code 206 and transmits the authorization code to the computing device 104A. The computing device 104A receives the authorization code 206 at operation 258 of the routine 250. The computing device 104A then provides the authorization code 206 to the account aggregation service 102 at operation 260.

The account aggregation service 102 receives the authorization code 206 at operation 276 of the routine 270. The account aggregation service 102 then transmits the authorization code 206 to the secondary network service 106B at operation 278. The secondary network service 106B receives the authorization code at operation 296 of the routine 290. From operation 296, the routine 290 proceeds from operation 296 to operation 298, where the secondary network service 106B generates the access token 208 and provides the access token 208 to the account aggregation service 102. As discussed above, the access token 208 is an OAuth access token in one particular configuration. Other types of access tokens can be utilized in other configurations. From operation 298, the routine 290 proceeds to operation 299, where it ends.

The account aggregation service 102 receives the access token 208 at operation 280 of the routine 270. The routine 270 then proceeds from operation 280 to operation 282, where the list of accounts 210 associated with the primary account credentials 108 is updated to include the secondary account identifier 202 and the access token 208 for the secondary network service 106B. The routine 270 then proceeds to operation 284, where the list of accounts 210 is provided to the computing device 104A. The routine 270 then proceeds from operation 284 to operation 286, where it ends.

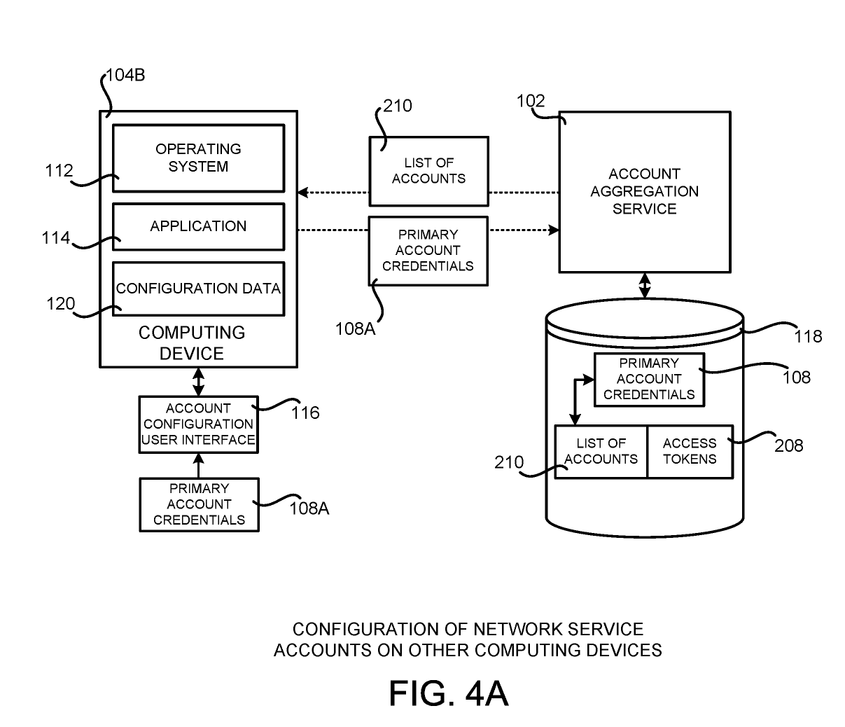

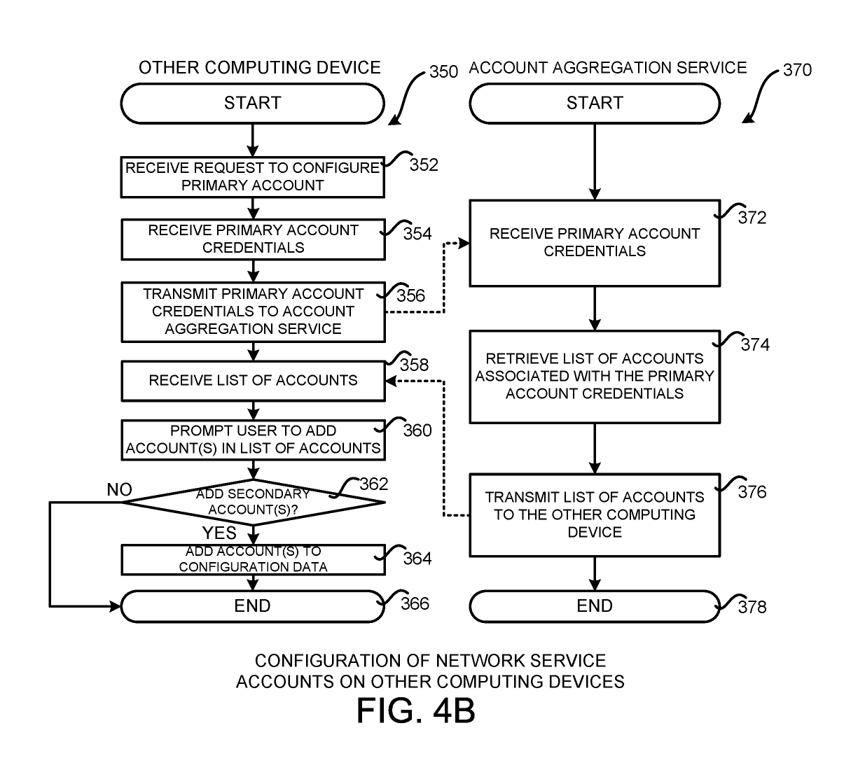

At operation 262 of the routine 250, the computing device 104A receives the list of accounts 210 and stores the list of accounts 210. The list of accounts 210 can be stored as configuration data 120 for the application 114 and/or operating system 112 in some configurations. From operation 262, the routine 200 proceeds to operation 264, where it ends. Details regarding the use of the list of accounts 210 to configure additional computing devices 104 will be provided below with regard to FIGS. 4A and 4B.

FIG. 3A is a network diagram showing aspects of one mechanism disclosed herein for retrieving data from one or more secondary network services 106B-106D via the account aggregation service 102, according to one configuration disclosed herein. As discussed briefly above, the account aggregation service 102 can also provide functionality for enabling computing devices, such as the computing device 104A, to access accounts 110 on the primary and secondary network services 106.

In order to provide this functionality, the account aggregation service 102 can receive requests 302 to access the secondary network services 106B-106D from the operating system 112 or the application 114 executing on the computing devices 104A. The operating system 112 and the application 114 can examine the configuration data 120 to determine the network services 110 that can be accessed. Using this information, the operating system 112 or the application 114 can generate requests 302 to the account aggregation service 102 to access various types of functionality provided by the network services 110.

In response to receiving such requests 302, the account aggregation service 102 can utilize the appropriate access token 304 to access the network services 106 on behalf of the user. For instance, in the example shown in FIG. 3A, requests 304B-304D including access tokens 208B-208D for the respective secondary network services 106B-106D have been generated. The secondary network services 106B-106D have generated responses 306B-306D, respectively, in response thereto.

Data contained in the responses 306B-306D can then be returned to the computing device 104 in a response 308 to the original request 302. The account aggregation service 102 can enable access to virtually any number of network services 106 in a similar fashion. For example, and without limitation, the account aggregation service 102 could enable an application 114 to access to multiple email services, social networking services, storage services, photo services, or combinations of such network services 106. As also discussed above, the computing device 104A can also access the primary and secondary network services 106 directly without using the account aggregation service 102.

FIG. 3B is a flow diagram showing aspects of a routine 320 that further illustrates the mechanism shown in FIG. 3A for retrieving data from one or more secondary network services 106B-106D via an account aggregation service 102, according to one configuration disclosed herein. The routine 320 begins at operation 322 where the account aggregation service 102 receives a request 302 from a computing device 104A to access a secondary network service 106. In response thereto, the routine 320 proceeds to operation 324, where the account aggregation service 102 transmits a request 304 to the appropriate secondary network service 106. As discussed above, the request 304 can include the proper access token 204 for the user making the request.

From operation 324, the routine 300 proceeds to operation 326, where the account aggregation service 102 receives a response 306 from the secondary network service 106 to which the request 304 was made. In response thereto, the routine 320 proceeds to operation 328, where the account aggregation service 102 can provide a response 308 to the request 302 that includes the data returned from the secondary network service 106. From operation 328, the routine 320 proceeds back to operation 322, described above, where additional requests 302 can be proceeds in a similar fashion.

FIG. 4A is a network diagram showing aspects of one mechanism disclosed herein for configuring one or more secondary network service accounts 110 on a second computing device 104B, according to one configuration disclosed herein. As discussed briefly above, the account aggregation service 102 can also enable the configuration of the secondary network services 106B-106D on a user's other computing devices, such as the computing device 104B, in a simplified fashion. In particular, in order to configure a user's other network service accounts 110 on a second computing device 104B, such as another smartphone or tablet computing device, the user simply has to identify their primary network service 106A and provide their credentials 108A for accessing the primary network service 106A. This information can be provided via the account configuration UI 116 in one particular configuration.

As shown in FIG. 4A, the primary account credentials 108A can be transmitted to the account aggregation service 102. The account aggregation service 102, in turn, can then utilize the primary account credentials 108 (e.g. the username for the primary network service) to retrieve the list of accounts 210 associated with the user. The list of accounts 210 can then be provided to the second computing device 104B.

In one particular configuration, the account configuration UI 116 allows the user to select the network service accounts in the list of accounts 210 that are to be configured on the second computing device 104B. Once the user has specified the accounts, the specified network service accounts 110 can be accessed by the account aggregation service 102 using the previously acquired access tokens 208 in the manner described above with regard to FIGS. 3A and 3B. The list of accounts 210 can also be made available to the operating system 112 and application programs 114 executing on the second computing device 104B for use in accessing the secondary network services 110 through the account aggregation service 102 in a similar fashion. In this way, the user of the computing device 104B only has to provide their credentials 108 for their secondary network service accounts 110 one time (i.e. as illustrated in FIGS. 2A and 2B) in order for these accounts to be provisioned on all of their computing devices 104.

FIG. 4B includes several flow diagrams showing aspects of two routines 350 and 370 that further illustrate the mechanism shown in FIG. 4A for configuring one or more secondary network service accounts on a second computing device, according to one configuration disclosed herein. In particular, the routine 350 illustrates the operations of a user's second computing device 104B and the routine 370 illustrates aspects of the operation of the account aggregation service 102. These routines will be described together below.

The routine 350 begins at operation 352, where the computing device 104B receives a request, such as through the account configuration UI 116, to configure network service accounts 110. The routine 350 then proceeds from operation 352 to operation 354, where the computing device 104B receives the primary account credentials 108A from the user. The primary account credentials 108A can also be received via the account configuration UI 116. The routine 350 then proceeds to operation 356.

At operation 356, the computing device 104B transmits the primary account credentials 108A to the account aggregation service 102. The account aggregation service 102 receives the primary account credentials 108A at operation 372 of the routine 370. The routine 370 then proceeds from operation 372 to operation 374, where the account aggregation service 102 retrieves the list of accounts 210 associated with the primary account credentials 108. The routine 370 then proceeds to operation 376, where the account aggregation service 102 transmits the list of accounts 210 to the computing device 104B. The routine 376 then proceeds to operation 378, where it ends.

The computing device 104B receives the list of accounts at operation 358 of the routine 350. The routine 350 then proceeds to operation 360, where the user of the computing device 104B can be asked to select the network service accounts 110 in the list of accounts 210 for which the computing device 104B is to be configured. This indication, and the user's selection of the accounts to be configured, can be provided by way of the account configuration UI 116.

If the user of the computing device 104B requests to configure the computing device 104B to access any of the secondary network service accounts 110 in the list of accounts 210, the routine 350 can proceed from operation 362 to operation 364, where the specified network service accounts 110 can be added to the configuration data 120 stored on the computing device 104B. As discussed above, the operating system 112 and the applications 114 can utilize the configuration data 120 to access the secondary network services 110 in the manner described above with regard to FIGS. 3A and 3B. The routine 350 then proceeds from operation 364 to operation 366, where it ends.

It should be appreciated that the operating system 112, application 114, account configuration user interface 116, account aggregation service 102, primary network service 106A, secondary network service 106B, and any of the other software components described above can be implemented using or in conjunction with binary executable files, dynamically linked libraries (“DLLs”), APIs, network services, script files, interpreted program code, software containers, object files, bytecode suitable for just-in-time compilation, and/or other types of program code that can be executed by a processor to perform the operations described herein with regard to FIGS. 1-7. Other types of software components not specifically mentioned herein can also be utilized.

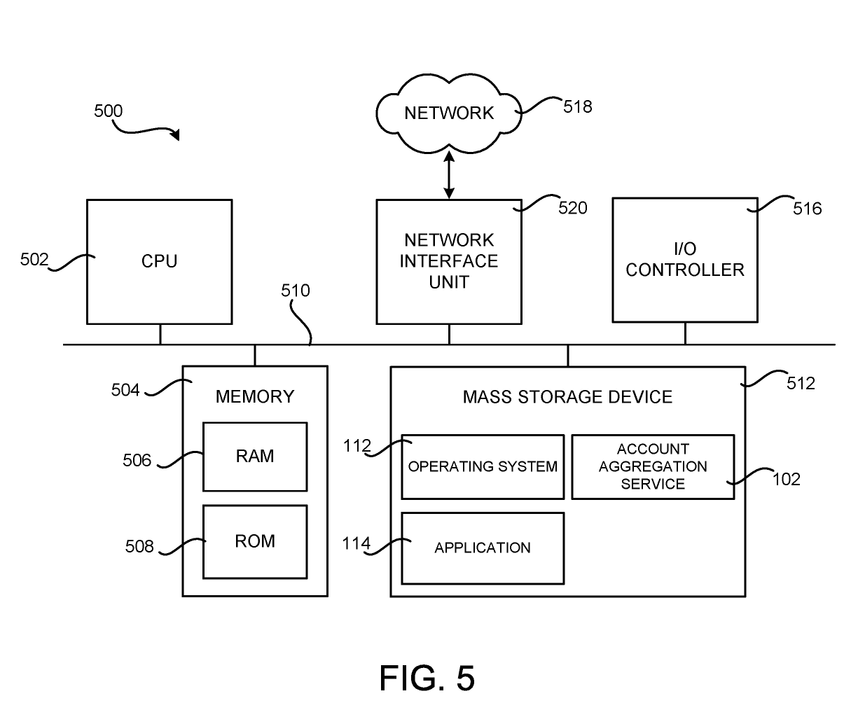

FIG. 5 is a computer architecture diagram that shows an architecture for a computer 500 capable of executing the software components described herein. The architecture illustrated in FIG. 5 is an architecture for a server computer, mobile phone, e-reader, smart phone, desktop computer, netbook computer, tablet computer, laptop computer, or another type of computing device suitable for executing the software components presented herein.

In this regard, it should be appreciated that the computer 500 shown in FIG. 5 can be utilized to implement a computing device capable of executing any of the software components presented herein. For example, and without limitation, the computing architecture described with reference to the computer 500 can be utilized to implement the computing devices 104A and 104B or server computers configured to implement the application 114, the account aggregation service 102, the primary network service 106A, the secondary network service 106B, and/or to implement other types of computing systems for executing any of the other software components described above.

The computer 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer 500, such as during startup, is stored in the ROM 508. The computer 500 further includes a mass storage device 512 for storing an operating system 112 and one or more programs including, but not limited to, the application 114, the account aggregation service, or software components implementing the primary or secondary network services 106A and 106B, depending upon the use of the computer 500. The mass storage device 512 can also be configured to store other types of programs and data not specifically shown in FIG. 5.

The mass storage device 512 is connected to the CPU 502 through a mass storage controller (not shown) connected to the bus 510. The mass storage device 512 and its associated computer readable media provide non-volatile storage for the computer 500. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 500. For purposes of the claims, the phrase “computer storage medium,” and variations thereof, does not include waves or signals per se or communication media.

According to various configurations, the computer 500 can operate in a networked environment using logical connections to remote computers through a network such as the network 518. The computer 500 can connect to the network 518 through a network interface unit 520 connected to the bus 510. It should be appreciated that the network interface unit 520 can also be utilized to connect to other types of networks and remote computer systems. The computer 500 can also include an input/output controller 516 for receiving and processing input from a number of other devices, including a keyboard, mouse, touch input, or electronic stylus (not shown in FIG. 5). Similarly, the input/output controller 516 can provide output to a display screen, a printer, or other type of output device (also not shown in FIG. 5).

It should be appreciated that the software components described herein, such as the application 114, the account aggregation service 102, the primary and secondary network services 106A and 106CB, can, when loaded into the CPU 502 and executed, transform the CPU 502 and the overall computer 500 from a general-purpose computing system into a special-purpose computing system customized to facilitate the functionality presented herein. The CPU 502 can be constructed from any number of transistors or other discrete circuit elements, which can individually or collectively assume any number of states. More specifically, the CPU 502 can operate as a finite-state machine, in response to executable instructions contained within the software modules disclosed herein. These computer-executable instructions can transform the CPU 502 by specifying how the CPU 502 transitions between states, thereby transforming the transistors or other discrete hardware elements constituting the CPU 502.

Encoding the software modules described herein can also transform the physical structure of the computer readable media presented herein. The specific transformation of physical structure depends on various factors, in different implementations of the disclosed technologies. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software components presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 500 in order to store and execute the software components presented herein. It should also be appreciated that the architecture shown in FIG. 5 for the computer 500, or a similar architecture, can be utilized to implement other types of computing devices, including hand-held computers, embedded computer systems, mobile devices such as smartphones and tablets, and other types of computing devices known to those skilled in the art. It is also contemplated that the computer 500 might not include all of the components shown in FIG. 5, can include other components that are not explicitly shown in FIG. 5, or can utilize an architecture completely different than that shown in FIG. 5.

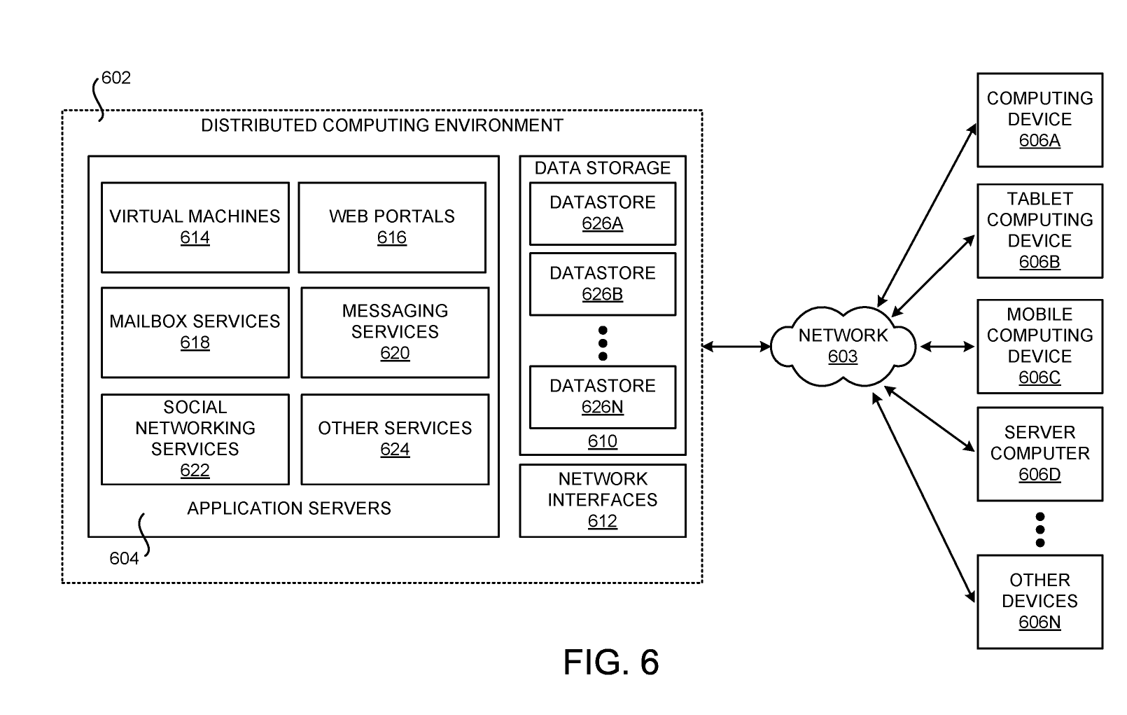

FIG. 6 shows aspects of an illustrative distributed computing environment 602 in which the software components described herein can be executed. Thus, the distributed computing environment 602 illustrated in FIG. 6 can be used to execute program code, such as the account aggregation service 102, the primary network service 106A, and the secondary network service 106B, which are capable of providing the functionality described herein with respect to FIGS. 1-4B, and/or any of the other software components described herein.

According to various implementations, the distributed computing environment 602 operates on, in communication with, or as part of a network 603. One or more client devices 606A-606N (hereinafter referred to collectively and/or generically as “clients 606”) can communicate with the distributed computing environment 602 via the network 603 and/or other connections (not illustrated in FIG. 6).

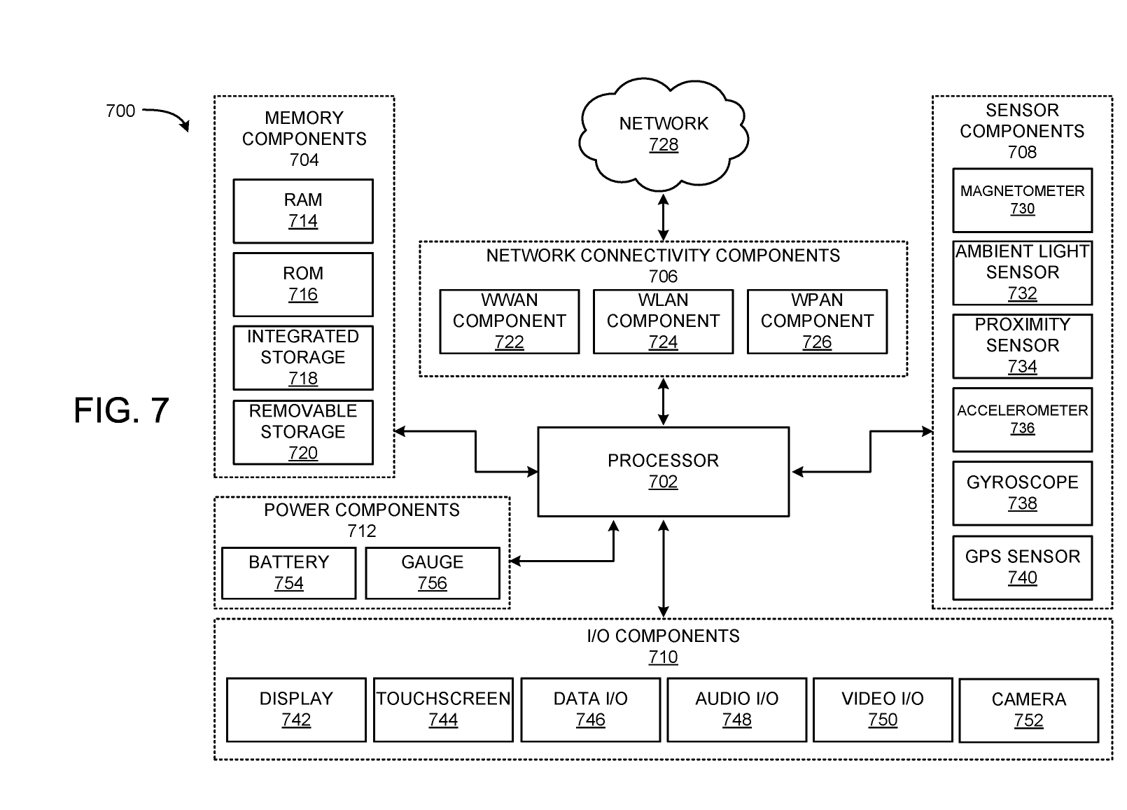

In the illustrated configuration, the clients 606 include: a computing device 606A such as a laptop computer, a desktop computer, or other computing device; a “slate” or tablet computing device (“tablet computing device”) 606B; a mobile computing device 606C such as a mobile telephone, a smart phone, or other mobile computing device; a server computer 606D; and/or other devices 606N. It should be understood that any number of clients 606 can communicate with the distributed computing environment 602. The computing devices 104A and 104B can also be clients of the distributed computing environment 602. Two example computing architectures for the clients 606 are illustrated and described herein with reference to FIGS. 5 and 7. It should be understood that the illustrated clients 606 and computing architectures illustrated and described herein are illustrative, and should not be construed as being limited in any way.

In the illustrated configuration, the distributed computing environment 602 includes application servers 604, data storage 610, and one or more network interfaces 612. According to various implementations, the functionality of the application servers 604 can be provided by one or more server computers that are executing as part of, or in communication with, the network 603. The application servers 604 can host various services such as the account aggregation service 102, the primary network service 106A or the secondary network service 106B described above, virtual machines, portals, and/or other resources. In the illustrated configuration, the application servers 604 host one or more virtual machines 614 for hosting applications or network services, such as the account aggregation service 102, the primary network service 106A or the secondary network service 106B, or other types of applications and/or services. According to various implementations, the virtual machines 614 host one or more applications and/or software modules, such as the account aggregation service 102, the primary network service 106A or the secondary network service 106B. It should be understood that this configuration is illustrative, and should not be construed as being limiting in any way. The application servers 604 might also host or provide access to one or more Web portals, link pages, Web sites, and/or other information (“Web portals”) 616.

According to various implementations, the application servers 604 also include one or more mailbox services 618 and one or more messaging services 620. The mailbox services 618 can include electronic mail (“email”) services. The mailbox services 618 can also include various personal information management (“PIM”) services including, but not limited to, calendar services, contact management services, collaboration services, and/or other services. The messaging services 620 can include, but are not limited to, instant messaging (“IM”) services, chat services, forum services, and/or other communication services.

The application servers 604 can also include one or more social networking services 622. The social networking services 622 can provide various types of social networking services including, but not limited to, services for sharing or posting status updates, instant messages, links, photos, videos, and/or other information, services for commenting or displaying interest in articles, products, blogs, or other resources, and/or other services. In some configurations, the social networking services 622 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 622 are provided by other services, sites, and/or providers that might be referred to as “social networking providers.” For example, some Web sites allow users to interact with one another via email, chat services, and/or other means during various activities and/or contexts such as reading published articles, commenting on goods or services, publishing, collaboration, gaming, and the like. Other services are possible and are contemplated.

The social networking services 622 can also include commenting, blogging, and/or microblogging services. Examples of such services include, but are not limited to, the YELP commenting service, the KUDZU review service, the OFFICETALK enterprise microblogging service, the TWITTER messaging service, the GOOGLE BUZZ service, and/or other services. It should be appreciated that the above lists of services are not exhaustive and that numerous additional and/or alternative social networking services 622 are not mentioned herein for the sake of brevity. As such, the configurations described above are illustrative, and should not be construed as being limited in any way.

As also shown in FIG. 6, the application servers 604 can also host other services, applications, portals, and/or other resources (“other services”) 624. The other services 624 can include, but are not limited to, the account aggregation service 102, the primary network service 106A or the secondary network service 106B and/or any of the other software components described herein. In this regard, it is to be appreciated that the primary network service 104A and the secondary network service 104B can include mailbox services 618, social networking services 622, web portals 616, messaging services 620, and/or other services 624. It can therefore be further appreciated that the distributed computing environment 602 can provide integration of the technologies disclosed herein with various mailbox, messaging, social networking, productivity, conversion, and/or other types of services or resources.

As mentioned above, the distributed computing environment 602 can include data storage 610. According to various implementations, the functionality of the data storage 610 is provided by one or more databases operating on, or in communication with, the network 603. The functionality of the data storage 610 can also be provided by one or more server computers configured to host data for the distributed computing environment 602. The data storage 610 can include, host, or provide one or more real or virtual datastores 626A-626N (hereinafter referred to collectively and/or generically as “datastores 626”). The datastores 626 are configured to host data used or created by the application servers 604 and/or other data.

The distributed computing environment 602 can communicate with, or be accessed by, the network interfaces 612. The network interfaces 612 can include various types of network hardware and software for supporting communications between two or more computing devices including, but not limited to, the clients 606 and the application servers 604. It should be appreciated that the network interfaces 612 can also be utilized to connect to other types of networks and/or computer systems.

It should be understood that the distributed computing environment 602 described herein can implement any aspects of the software elements described herein with any number of virtual computing resources and/or other distributed computing functionality that can be configured to execute any aspects of the software components disclosed herein. According to various implementations of the technologies disclosed herein, the distributed computing environment 602 provides some or all of the software functionality described herein as a service to the clients 606. It should be understood that the clients 606 can also include real or virtual machines including, but not limited to, server computers, Web servers, personal computers, mobile computing devices, smart phones, and/or other devices. As such, various implementations of the technologies disclosed herein enable any device configured to access the distributed computing environment 602 to utilize the functionality described herein.

Turning now to FIG. 7, an illustrative computing device architecture 700 will be described for a computing device that is capable of executing the various software components described herein. The computing device architecture 700 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like.

The computing device architecture 700 is also applicable to any of the clients 606 shown in FIG. 6. Furthermore, aspects of the computing device architecture 700 are applicable to traditional desktop computers, portable computers (e.g., laptops, notebooks, ultra-portables, and netbooks), server computers, and other computer systems, such as those described herein with reference to FIG. 7. For example, the single touch and multi-touch aspects disclosed herein below can be applied to desktop computers that utilize a touchscreen or some other touch-enabled device, such as a touch-enabled track pad or touch-enabled mouse. The computing device architecture 700 can also be utilized to implement the computing devices 104A and 104B, and/or other types of computing devices for implementing or consuming the functionality described herein.

The computing device architecture 700 illustrated in FIG. 7 includes a processor 702, memory components 704, network connectivity components 706, sensor components 708, input/output components 710, and power components 712. In the illustrated configuration, the processor 702 is in communication with the memory components 704, the network connectivity components 706, the sensor components 708, the input/output (“I/O”) components 710, and the power components 712. Although no connections are shown between the individual components illustrated in FIG. 7, the components can be connected electrically in order to interact and carry out device functions. In some configurations, the components are arranged so as to communicate via one or more busses (not shown).

The processor 702 includes one or more central processing unit (“CPU”) cores configured to process data, execute computer-executable instructions of one or more application programs, such as the application 114, and to communicate with other components of the computing device architecture 700 in order to perform aspects of the functionality described herein. The processor 702 can be utilized to execute aspects of the software components presented herein and, particularly, those that utilize, at least in part, a touch-enabled input.

In some configurations, the processor 702 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, 4K, and greater), video games, 3D modeling applications, and the like. In some configurations, the processor 702 is configured to communicate with a discrete GPU (not shown). In any case, the CPU and GPU can be configured in accordance with a co-processing CPU/GPU computing model, wherein the sequential part of an application executes on the CPU and the computationally intensive part is accelerated by the GPU.

In some configurations, the processor 702 is, or is included in, a system-on-chip (“SoC”) along with one or more of the other components described herein below. For example, the SoC can include the processor 702, a GPU, one or more of the network connectivity components 706, and one or more of the sensor components 708. In some configurations, the processor 702 is fabricated, in part, utilizing a package-on-package (“PoP”) integrated circuit packaging technique. Moreover, the processor 702 can be a single core or multi-core processor.

The processor 702 can be created in accordance with an ARM architecture, available for license from ARM HOLDINGS of Cambridge, United Kingdom. Alternatively, the processor 702 can be created in accordance with an x86 architecture, such as is available from INTEL CORPORATION of Mountain View, Calif. and others. In some configurations, the processor 702 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 704 include a RAM 714, a ROM 716, an integrated storage memory (“integrated storage”) 718, and a removable storage memory (“removable storage”) 720. In some configurations, the RAM 714 or a portion thereof, the ROM 716 or a portion thereof, and/or some combination of the RAM 714 and the ROM 716 is integrated in the processor 702. In some configurations, the ROM 716 is configured to store a firmware, an operating system or a portion thereof (e.g., operating system kernel), and/or a bootloader to load an operating system kernel from the integrated storage 718 or the removable storage 720.

The integrated storage 718 can include a solid-state memory, a hard disk, or a combination of solid-state memory and a hard disk. The integrated storage 718 can be soldered or otherwise connected to a logic board upon which the processor 702 and other components described herein might also be connected. As such, the integrated storage 718 is integrated into the computing device. The integrated storage 718 can be configured to store an operating system or portions thereof, application programs, data, and other software components described herein.

The removable storage 720 can include a solid-state memory, a hard disk, or a combination of solid-state memory and a hard disk. In some configurations, the removable storage 720 is provided in lieu of the integrated storage 718. In other configurations, the removable storage 720 is provided as additional optional storage. In some configurations, the removable storage 720 is logically combined with the integrated storage 718 such that the total available storage is made available and shown to a user as a total combined capacity of the integrated storage 718 and the removable storage 720.

The removable storage 720 is configured to be inserted into a removable storage memory slot (not shown) or other mechanism by which the removable storage 720 is inserted and secured to facilitate a connection over which the removable storage 720 can communicate with other components of the computing device, such as the processor 702. The removable storage 720 can be embodied in various memory card formats including, but not limited to, PC card, COMPACTFLASH card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 704 can store an operating system. According to various configurations, the operating system includes, but is not limited to, the WINDOWS MOBILE OS, the WINDOWS PHONE OS, or the WINDOWS OS from MICROSOFT CORPORATION, BLACKBERRY OS from RESEARCH IN MOTION, LTD. of Waterloo, Ontario, Canada, IOS from APPLE INC. of Cupertino, Calif., and ANDROID OS from GOOGLE, INC. of Mountain View, Calif. Other operating systems are contemplated.

The network connectivity components 706 include a wireless wide area network component (“WWAN component”) 722, a wireless local area network component (“WLAN component”) 724, and a wireless personal area network component (“WPAN component”) 726. The network connectivity components 706 facilitate communications to and from a network 728, which can be a WWAN, a WLAN, or a WPAN. Although a single network 728 is illustrated, the network connectivity components 706 can facilitate simultaneous communication with multiple networks. For example, the network connectivity components 706 can facilitate simultaneous communications with multiple networks via one or more of a WWAN, a WLAN, or a WPAN.

The network 728 can be a WWAN, such as a mobile telecommunications network utilizing one or more mobile telecommunications technologies to provide voice and/or data services to a computing device utilizing the computing device architecture 700 via the WWAN component 722. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”).

Moreover, the network 728 can utilize various channel access methods (which might or might not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications can be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 728 can be configured to provide voice and/or data communications with any combination of the above technologies. The network 728 can be configured or adapted to provide voice and/or data communications in accordance with future generation technologies.

In some configurations, the WWAN component 722 is configured to provide dual-multi-mode connectivity to the network 728. For example, the WWAN component 722 can be configured to provide connectivity to the network 728, wherein the network 728 provides service via GSM and UMTS technologies, or via some other combination of technologies. Alternatively, multiple WWAN components 722 can be utilized to perform such functionality, and/or provide additional functionality to support other non-compatible technologies (i.e., incapable of being supported by a single WWAN component). The WWAN component 722 can facilitate similar connectivity to multiple networks (e.g., a UMTS network and an LTE network).

The network 728 can be a WLAN operating in accordance with one or more Institute of Electrical and Electronic Engineers (“IEEE”) 104.11 standards, such as IEEE 104.11a, 104.11b, 104.11g, 104.11n, and/or a future 104.11 standard (referred to herein collectively as WI-FI). Draft 104.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 724 is configured to connect to the network 728 via the WI-FI access points. Such connections can be secured via various encryption technologies including, but not limited, WI-FI Protected Access (“WPA”), WPA2, Wired Equivalent Privacy (“WEP”), and the like.

The network 728 can be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 726 is configured to facilitate communications with other devices, such as peripherals, computers, or other computing devices via the WPAN.

The sensor components 708 include a magnetometer 730, an ambient light sensor 732, a proximity sensor 734, an accelerometer 736, a gyroscope 738, and a Global Positioning System sensor (“GPS sensor”) 740. It is contemplated that other sensors, such as, but not limited to, temperature sensors or shock detection sensors, might also be incorporated in the computing device architecture 700.

The magnetometer 730 is configured to measure the strength and direction of a magnetic field. In some configurations the magnetometer 730 provides measurements to a compass application program stored within one of the memory components 704 in order to provide a user with accurate directions in a frame of reference including the cardinal directions, north, south, east, and west. Similar measurements can be provided to a navigation application program that includes a compass component. Other uses of measurements obtained by the magnetometer 730 are contemplated.

The ambient light sensor 732 is configured to measure ambient light. In some configurations, the ambient light sensor 732 provides measurements to an application program, such as the application 304, stored within one of the memory components 704 in order to automatically adjust the brightness of a display (described below) to compensate for low light and bright light environments. Other uses of measurements obtained by the ambient light sensor 732 are contemplated.

The proximity sensor 734 is configured to detect the presence of an object or thing in proximity to the computing device without direct contact. In some configurations, the proximity sensor 734 detects the presence of a user's body (e.g., the user's face) and provides this information to an application program stored within one of the memory components 704 that utilizes the proximity information to enable or disable some functionality of the computing device. For example, a telephone application program can automatically disable a touchscreen (described below) in response to receiving the proximity information so that the user's face does not inadvertently end a call or enable/disable other functionality within the telephone application program during the call. Other uses of proximity as detected by the proximity sensor 734 are contemplated.

The accelerometer 736 is configured to measure proper acceleration. In some configurations, output from the accelerometer 736 is used by an application program as an input mechanism to control some functionality of the application program. In some configurations, output from the accelerometer 736 is provided to an application program for use in switching between landscape and portrait modes, calculating coordinate acceleration, or detecting a fall. Other uses of the accelerometer 736 are contemplated.

The gyroscope 738 is configured to measure and maintain orientation. In some configurations, output from the gyroscope 738 is used by an application program as an input mechanism to control some functionality of the application program. For example, the gyroscope 738 can be used for accurate recognition of movement within a 3D environment of a video game application or some other application. In some configurations, an application program utilizes output from the gyroscope 738 and the accelerometer 736 to enhance control of some functionality of the application 114. Other uses of the gyroscope 738 are contemplated.

The GPS sensor 740 is configured to receive signals from GPS satellites for use in calculating a location. The location calculated by the GPS sensor 740 can be used by any application program that requires or benefits from location information. For example, the location calculated by the GPS sensor 740 can be used with a navigation application program to provide directions from the location to a destination or directions from the destination to the location. Moreover, the GPS sensor 740 can be used to provide location information to an external location-based service, such as E911 service. The GPS sensor 740 can obtain location information generated via WI-FI, WIMAX, and/or cellular triangulation techniques utilizing one or more of the network connectivity components 706 to aid the GPS sensor 740 in obtaining a location fix. The GPS sensor 740 can also be used in Assisted GPS (“A-GPS”) systems.

The I/O components 710 include a display 742, a touchscreen 744, a data I/O interface component (“data I/O”) 746, an audio I/O interface component (“audio I/O”) 748, a video I/O interface component (“video I/O”) 750, and a camera 752. In some configurations, the display 742 and the touchscreen 744 are combined. In some configurations two or more of the data I/O component 746, the audio I/O component 748, and the video I/O component 750 are combined. The I/O components 710 can include discrete processors configured to support the various interfaces described below, or might include processing functionality built-in to the processor 702.

The display 742 is an output device configured to present information in a visual form. In particular, the display 742 can present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 742 is a liquid crystal display (“LCD”) utilizing any active or passive matrix technology and any backlighting technology (if used). In some configurations, the display 742 is an organic light emitting diode (“OLED”) display. Other display types are contemplated.

The touchscreen 744 is an input device configured to detect the presence and location of a touch. The touchscreen 744 can be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or can utilize any other touchscreen technology. In some configurations, the touchscreen 744 is incorporated on top of the display 742 as a transparent layer to enable a user to use one or more touches to interact with objects or other information presented on the display 742. In other configurations, the touchscreen 744 is a touch pad incorporated on a surface of the computing device that does not include the display 742. For example, the computing device can have a touchscreen incorporated on top of the display 742 and a touch pad on a surface opposite the display 742.

In some configurations, the touchscreen 744 is a single-touch touchscreen. In other configurations, the touchscreen 744 is a multi-touch touchscreen. In some configurations, the touchscreen 744 is configured to detect discrete touches, single touch gestures, and/or multi-touch gestures. These are collectively referred to herein as “gestures” for convenience. Several gestures will now be described. It should be understood that these gestures are illustrative and are not intended to limit the scope of the appended claims. Moreover, the described gestures, additional gestures, and/or alternative gestures can be implemented in software for use with the touchscreen 744. As such, a developer can create gestures that are specific to a particular application program.

In some configurations, the touchscreen 744 supports a tap gesture in which a user taps the touchscreen 744 once on an item presented on the display 742. The tap gesture can be used for various reasons including, but not limited to, opening or launching whatever the user taps, such as a graphical icon representing the application 304. In some configurations, the touchscreen 744 supports a double tap gesture in which a user taps the touchscreen 744 twice on an item presented on the display 742. The double tap gesture can be used for various reasons including, but not limited to, zooming in or zooming out in stages. In some configurations, the touchscreen 744 supports a tap and hold gesture in which a user taps the touchscreen 744 and maintains contact for at least a pre-defined time. The tap and hold gesture can be used for various reasons including, but not limited to, opening a context-specific menu.

In some configurations, the touchscreen 744 supports a pan gesture in which a user places a finger on the touchscreen 744 and maintains contact with the touchscreen 744 while moving the finger on the touchscreen 744. The pan gesture can be used for various reasons including, but not limited to, moving through screens, images, or menus at a controlled rate. Multiple finger pan gestures are also contemplated. In some configurations, the touchscreen 744 supports a flick gesture in which a user swipes a finger in the direction the user wants the screen to move. The flick gesture can be used for various reasons including, but not limited to, scrolling horizontally or vertically through menus or pages. In some configurations, the touchscreen 744 supports a pinch and stretch gesture in which a user makes a pinching motion with two fingers (e.g., thumb and forefinger) on the touchscreen 744 or moves the two fingers apart. The pinch and stretch gesture can be used for various reasons including, but not limited to, zooming gradually in or out of a website, map, or picture.

Although the gestures described above have been presented with reference to the use of one or more fingers for performing the gestures, other appendages such as toes or objects such as styluses can be used to interact with the touchscreen 744. As such, the above gestures should be understood as being illustrative and should not be construed as being limiting in any way.

The data I/O interface component 746 is configured to facilitate input of data to the computing device and output of data from the computing device. In some configurations, the data I/O interface component 746 includes a connector configured to provide wired connectivity between the computing device and a computer system, for example, for synchronization operation purposes. The connector can be a proprietary connector or a standardized connector such as USB, micro-USB, mini-USB, USB-C, or the like. In some configurations, the connector is a dock connector for docking the computing device with another device such as a docking station, audio device (e.g., a digital music player), or video device.

The audio I/O interface component 748 is configured to provide audio input and/or output capabilities to the computing device. In some configurations, the audio I/O interface component 746 includes a microphone configured to collect audio signals. In some configurations, the audio I/O interface component 748 includes a headphone jack configured to provide connectivity for headphones or other external speakers. In some configurations, the audio interface component 748 includes a speaker for the output of audio signals. In some configurations, the audio I/O interface component 748 includes an optical audio cable out.

The video I/O interface component 750 is configured to provide video input and/or output capabilities to the computing device. In some configurations, the video I/O interface component 750 includes a video connector configured to receive video as input from another device (e.g., a video media player such as a DVD or BLU-RAY player) or send video as output to another device (e.g., a monitor, a television, or some other external display). In some configurations, the video I/O interface component 750 includes a High-Definition Multimedia Interface (“HDMI”), mini-HDMI, micro-HDMI, DisplayPort, or proprietary connector to input/output video content. In some configurations, the video I/O interface component 750 or portions thereof is combined with the audio I/O interface component 748 or portions thereof.

The camera 752 can be configured to capture still images and/or video. The camera 752 can utilize a charge coupled device (“CCD”) or a complementary metal oxide semiconductor (“CMOS”) image sensor to capture images. In some configurations, the camera 752 includes a flash to aid in taking pictures in low-light environments. Settings for the camera 752 can be implemented as hardware or software buttons.

Although not illustrated, one or more hardware buttons can also be included in the computing device architecture 700. The hardware buttons can be used for controlling some operational aspect of the computing device. The hardware buttons can be dedicated buttons or multi-use buttons. The hardware buttons can be mechanical or sensor-based.

The illustrated power components 712 include one or more batteries 754, which can be connected to a battery gauge 756. The batteries 754 can be rechargeable or disposable. Rechargeable battery types include, but are not limited to, lithium polymer, lithium ion, nickel cadmium, and nickel metal hydride. Each of the batteries 754 can be made of one or more cells.

The battery gauge 756 can be configured to measure battery parameters such as current, voltage, and temperature. In some configurations, the battery gauge 756 is configured to measure the effect of a battery's discharge rate, temperature, age and other factors to predict remaining life within a certain percentage of error. In some configurations, the battery gauge 756 provides measurements to an application program that is configured to utilize the measurements to present useful power management data to a user. Power management data can include one or more of a percentage of battery used, a percentage of battery remaining, a battery condition, a remaining time, a remaining capacity (e.g., in watt hours), a current draw, and a voltage.

The power components 712 can also include a power connector (not shown), which can be combined with one or more of the aforementioned I/O components 710. The power components 712 can interface with an external power system or charging equipment via a power I/O component. Other configurations can also be utilized.

The disclosure presented herein also encompasses the subject matter set forth in the following clauses:

Clause 1: A computer-implemented method, comprising: receiving from a first computing device user credentials for a first network service; obtaining an access token for accessing a second network service; associating the user credentials for the first network service with a list of accounts and the access token for accessing the second network service, the list of accounts comprising data describing the second network service; receiving a request from a second computing device to configure the second computing device to access the second network service, the request comprising the user credentials for accessing the first network service; and responsive to receiving the request, providing the list of accounts to the second computing device for configuring the second computing device to access the second network service.

Clause 2: The computer-implemented method of clause 1, further comprising: receiving a request from the second computing device to retrieve data from the second network service; and responsive to receiving the request, utilizing the access token for accessing the second network service to retrieve the data from the second network service; and providing the data to the second computing device.

Clause 3: The computer implemented method of any of clauses 1-2, further comprising: receiving a request from a third computing device to configure the third computing device to access the second network service, the request comprising the user credentials for accessing the first network service; and responsive to receiving the request, providing the list of accounts to the third computing device for configuring the third computing device to access the second network service.

Clause 4: The computer-implemented method of any of clauses 1-3, further comprising: receiving a request from the third computing device to retrieve data from the second network service; and responsive to receiving the request, utilizing the access token for accessing the second network service to retrieve the data from the second network service; and providing the data to the third computing device.

Clause 5: The computer-implemented method of any of clauses 1-4, wherein the data describing the second network service comprises data identifying a network address of the second network service.

Clause 6: The computer-implemented method of any of clauses 1-5, wherein the data describing the second network service further comprises data identifying a type of the second network service.

Clause 7: The computer-implemented method of any of clauses 1-6, wherein the access token comprises an OAuth access token.

Clause 8: The computer-implemented method of any of clauses 1-7, wherein configuring the second computing device to access the second network service comprises making the list of accounts available to an application or an operating system executing on the second computing device.

Clause 9: The computer-implemented method of any of clauses 1-8, wherein the first network service comprises a first electronic mail service and wherein the second network service comprises a second electronic mail service.

Clause 10: An apparatus, comprising: one or more processors; and at least one computer storage medium having computer executable instructions stored thereon which, when executed by the one or more processors, cause the apparatus to receive from a first computing device user credentials for a first network service, obtain an access token for accessing a second network service, associate the user credentials for the first network service with a list of accounts and the access token for accessing the second network service, the list of accounts comprising data describing the second network service, receive a request from a second computing device to configure the second computing device to access the second network service, the request comprising the user credentials for accessing the first network service, and in response to receiving the request, provide the list of accounts to the second computing device for configuring the second computing device to access the second network service.

Clause 11: The apparatus of clause 10, wherein the at least one computer storage medium has further computer executable instructions stored thereupon to: receive a request from the second computing device to retrieve data from the second network service; and in response to receiving the request, utilize the access token for accessing the second network service to retrieve the data from the second network service; and provide the data to the second computing device.

Clause 12: The apparatus of any of clauses 10-11, wherein the access token comprises an OAuth access token.

Clause 13: The apparatus of any of clauses 10-12, wherein configuring the second computing device to access the second network service comprises making the list of accounts available to an application or an operating system executing on the second computing device.

Clause 14: The apparatus of any of clauses 10-13, wherein the data describing the second network service comprises data identifying a network address of the second network service.

Clause 15: The apparatus of any of clauses 10-14, wherein the data describing the second network service further comprises data identifying a type of the second network service.

Clause 16: A computer storage medium having computer executable instructions stored thereon which, when executed by one or more processors, cause the processors to: receive from a first computing device user credentials for a first network service; obtain an access token for accessing a second network service; associate the user credentials for the first network service with a list of accounts and the access token for accessing the second network service, the list of accounts comprising data describing the second network service; receive a request from a second computing device to configure the second computing device to access the second network service, the request comprising the user credentials for accessing the first network service; and in response to receiving the request, provide the list of accounts to the second computing device for configuring the second computing device to access the second network service.

Clause 17: The computer storage medium of clause 16, wherein the at least one computer storage medium has further computer executable instructions stored thereupon to: receive a request from the second computing device to retrieve data from the second network service; and in response to receiving the request, utilize the access token for accessing the second network service to retrieve the data from the second network service; and provide the data to the second computing device.

Clause 18: The computer storage medium of any of clauses 16-17, wherein the access token comprises an OAuth access token.

Clause 19: The computer storage medium of any of clauses 16-18, wherein the data describing the second network service comprises data identifying a network address of the second network service.

Clause 20: The computer storage medium of any of clauses 16-19, wherein the data describing the second network service further comprises data identifying a type of the second network service.

Based on the foregoing, it should be appreciated that various technologies for simplified configuration of computing devices for use with multiple network services have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method, comprising:
receiving from a first computing device user credentials for a first network service;
obtaining an access token for accessing a second network service;
associating the user credentials for the first network service with a list of accounts and the access token for accessing the second network service, the list of accounts comprising data describing the second network service;
receiving a request from a second computing device to configure the second computing device to access the second network service, the request comprising the user credentials for accessing the first network service; and
responsive to receiving the request, providing the list of accounts to the second computing device for configuring the second computing device to access the second network service.

2. The computer-implemented method of claim 1, further comprising:
receiving a request from the second computing device to retrieve data from the second network service; and
responsive to receiving the request, utilizing the access token for accessing the second network service to retrieve the data from the second network service; and
providing the data to the second computing device.

3. The computer implemented method of claim 1, further comprising:
receiving a request from a third computing device to configure the third computing device to access the second network service, the request comprising the user credentials for accessing the first network service; and
responsive to receiving the request, providing the list of accounts to the third computing device for configuring the third computing device to access the second network service.

4. The computer-implemented method of claim 3, further comprising:
receiving a request from the third computing device to retrieve data from the second network service; and
responsive to receiving the request, utilizing the access token for accessing the second network service to retrieve the data from the second network service; and
providing the data to the third computing device.

5. The computer-implemented method of claim 1, wherein the data describing the second network service comprises data identifying a network address of the second network service.

6. The computer-implemented method of claim 5, wherein the data describing the second network service further comprises data identifying a type of the second network service.

7. The computer-implemented method of claim 1, wherein the access token comprises an OAuth access token.

8. The computer-implemented method of claim 1, wherein configuring the second computing device to access the second network service comprises making the list of accounts available to an application or an operating system executing on the second computing device.

9. The computer-implemented method of claim 1, wherein the first network service comprises a first electronic mail service and wherein the second network service comprises a second electronic mail service.

10. An apparatus, comprising:
one or more processors; and
at least one computer storage medium having computer executable instructions stored thereon which, when executed by the one or more processors, cause the apparatus to
receive from a first computing device user credentials for a first network service,
obtain an access token for accessing a second network service,
associate the user credentials for the first network service with a list of accounts and the access token for accessing the second network service, the list of accounts comprising data describing the second network service,
receive a request from a second computing device to configure the second computing device to access the second network service, the request comprising the user credentials for accessing the first network service, and
in response to receiving the request, provide the list of accounts to the second computing device for configuring the second computing device to access the second network service.

11. The apparatus of claim 10, wherein the at least one computer storage medium has further computer executable instructions stored thereupon to:
receive a request from the second computing device to retrieve data from the second network service; and
in response to receiving the request, utilize the access token for accessing the second network service to retrieve the data from the second network service; and
provide the data to the second computing device.

12. The apparatus of claim 10, wherein the access token comprises an OAuth access token.

13. The apparatus of claim 10, wherein configuring the second computing device to access the second network service comprises making the list of accounts available to an application or an operating system executing on the second computing device.

14. The apparatus of claim 10, wherein the data describing the second network service comprises data identifying a network address of the second network service.

15. The apparatus of claim 14, wherein the data describing the second network service further comprises data identifying a type of the second network service.

16. A computer storage medium having computer executable instructions stored thereon which, when executed by one or more processors, cause the processors to:
receive from a first computing device user credentials for a first network service;
obtain an access token for accessing a second network service;
associate the user credentials for the first network service with a list of accounts and the access token for accessing the second network service, the list of accounts comprising data describing the second network service;
receive a request from a second computing device to configure the second computing device to access the second network service, the request comprising the user credentials for accessing the first network service; and
in response to receiving the request, provide the list of accounts to the second computing device for configuring the second computing device to access the second network service.

17. The computer storage medium of claim 16, wherein the at least one computer storage medium has further computer executable instructions stored thereupon to:
receive a request from the second computing device to retrieve data from the second network service; and
in response to receiving the request, utilize the access token for accessing the second network service to retrieve the data from the second network service; and
provide the data to the second computing device.

18. The computer storage medium of claim 16, wherein the access token comprises an OAuth access token.

19. The computer storage medium of claim 16, wherein the data describing the second network service comprises data identifying a network address of the second network service.

20. The computer storage medium of claim 19, wherein the data describing the second network service further comprises data identifying a type of the second network service.
